(19) United States
(12) Patent Application Publication
(10) Pub. No.: US 2004/0035788 A1
(43) Pub. Date: Feb. 26, 2004

(54) Method for the gasification of liquid to pasty organic substances and substance mixtures

(76) Inventors: Christoph Schmid, Bergneustadt (DE); Heinz-Jurgen Muhlen, Munster (DE)

Correspondence Address: WILLIAM COLLARD, COLLARD & ROE, P.C., 1077 NORTHERN BOULEVARD, ROSLYN, NY, 11576, US

(21) Appl. No.: 10/416,137

(22) PCT Filed: Nov. 8, 2001
(86) PCT No.: PCT/EP01/12931

(30) Foreign Application Priority Data
Nov. 8, 2000 (DE) 100 55 360.5

(51) Int. Cl. B01D 11/00

(52) U.S. Cl. 210/634; 210/774

(57) ABSTRACT

The invention relates to a method for gasifying liquid to pasty organic substances and substance mixtures. According to the invention, the organic substances are converted to a substantially volatile phase in a pyrolysis reactor by contacting them with a hot heat transfer medium. Once a reactant such as water vapor is optionally added, the volatile phase is heated up in a second reaction zone, configured as a moving bed reactor, to such an extent that a product gas with a high calorific value is obtained. The heated up and partially reacted gas mixture is fed to a third reaction zone in which it finally reacts with a catalytically active material, heated up to reaction temperature and different from the heat transfer material, to give the product gas. A flow of hot residual gases of the furnace is used to heat up the heat transfer medium while being cooled.

The invention relates to a method for the gasification of liquid to pasty organic substances and substance mixtures in accordance with the preamble of claim 1.

PCT document WO99/04861 [1] has disclosed a method for disposing of liquid residues in which these residues are introduced into a reactor which includes a bulk bed of coarse particles of a high-melting alkaline earth metal oxide, preferably calcium oxide. This bulk bed is held at temperatures between 800 and 1100° C. Within this temperature range, the organic material decomposes into a gas, which mainly contains hydrogen, but also hydrocarbons and other gaseous species. A simple reckoning up of the individual chemical elements introduced teaches that at least one reagent, such as steam, must be added to the liquid substance which is to be disposed of in this way, so that the formation of soot—as virtually pure carbon—can be reliably prevented. A problem which is particularly characteristic of this method consists in the fact that all the heat which is required to evaporate and thermally decompose the charge substance has to be introduced externally via the reactor walls. It has already been possible to demonstrate the functionality of this method with water-containing emulsions in a quantity of a few kilograms per hour on a pilot scale [2]. However, this form of introducing heat is no longer suitable for supplying sufficient heat to the process for quantities of residue which are significantly greater, and consequently, by way of example, a plurality of reactors would have to be connected in parallel to enable the method to take place at all. This is scarcely economically viable. DE-C 197 55 693 [3] has disclosed a method for gasifying organic substances and substance mixtures which is able to solve this problem. In this method, the organic substances are brought into contact, in a migrating bed reactor, with an inert heat-transfer medium which is in the form of fine lumps, with the result that, after partial evaporation if appropriate, rapid pyrolysis takes place, during which the organic substances are in part converted into a carbonaceous, solid residue and in part into a pyrolysis gas consisting of condensable, volatile and gaseous constituents.

Then, the heat-transfer medium and the pyrolysis coke are fed to a combustion stage, in which on the one hand the carbonaceous residue is burnt and on the other hand the heat-transfer medium is heated before being fed back to the pyrolysis after it has been separated from the combustion residues. This means that a remainder substance which is disposed of in this way itself brings the heat required for this purpose with it by means of the chemical energy which it contains.

The pyrolysis gas generally still contains condensable residues and, after a reagent—usually steam—has been added, is reheated in a second reaction zone, which is designed as an indirect heat exchanger, in such a manner that, after reaction, a product gas with a high calorific value is obtained, the indirect heating of this heat exchanger being effected by means of the combustion off-gases as the latter are cooled.

After the firing, the ash from a partial stream of the mixture comprising heat-transfer medium and ash of the solid, carbonaceous residue is mechanically separated from the heat-transfer medium, cooled and discharged.

However, this method has a number of aspects which make an apparatus for carrying out this method complex and expensive and may have an adverse effect on both the operation and the availability: firstly, the heat-transfer medium is returned from the combustion to the pyrolysis in the heated state, i.e. at a temperature which is well above the pyrolysis temperature, which is given as 550-650° C. As a result, it is necessary to use conveyor elements which are particularly mechanically complex and expensive in terms of materials. Furthermore, if the heated heat-transfer medium is still mixed with ash, it is likely that the ash will soften and thereby cause caking problems. Secondly, the indirect heat exchanger used, on account of its working conditions—temperatures of 500-1000° C. on both sides, reducing conditions on one side, highly corrosive constituents in both the pyrolysis gas and the product gas and in the combustion off-gas—requires very expensive materials and, on account of possible ash softening, an additional cleaning system, which under certain circumstances may be a complex problem. The risk of ash caking on in the heat exchanger also imposes tight restrictions on the operation and configuration of the firing stage. A further difficulty consists in admixing steam to the pyrolysis gases: either the steam is highly superheated with a considerable level of outlay or the temperature drops, which can lead to condensation of tar and therefore to caking problems. Finally, situations may also be encountered in which a defined heat transfer to the heat-transfer medium which is to be reheated cannot be ensured in the firing stage. Consequently, there is a risk of the pyrolysis coke and the heat-transfer medium being segregated in the firing stage, with the result that, by way of example, in the case of grate firing, the pyrolysis coke burns off on the top of the layer while the heat-transfer medium may even be cooled by the grate air which is still flowing in from below. A further method, the development of which is linked [4] to the method presented in [3], avoids the drawbacks mentioned above: the heat-transfer medium circuit incorporates the second reaction zone, which is now no longer designed as a heat exchanger, but rather is designed as a migrating bed reactor, and is therefore no longer susceptible to soiling and caking.

Furthermore, the pyrolysis coke, after it has left the pyrolysis reactor, is separated from the heat-transfer medium and then burnt, and the hot gases formed are passed through a further migrating bed reactor located above the second reaction zone. Consequently, defined heating of the heat-transfer medium is achieved in this migrating bed reactor. This method can be used to gasify not only solid residual substances but also in principle liquid and pasty substances. Even “gasification”, i.e. the reforming of gaseous residues, e.g. coke-oven gases or refinery gases, can be achieved without problems. However, most liquid to pasty charge substances are distinguished by the fact that little or no pyrolysis coke is formed when they are heated to the temperature of the pyrolysis stage, which correspondingly leads to low quantities of ash. This means that when exclusively substances of this nature are used, it is possible to dispense with the separation of heat-transfer medium and pyrolysis coke. Moreover, the efficient utilization of a substance which has a catalytic action on the reactions of breaking down the hydrocarbons supplied cannot readily be integrated in this method, since the metering of this substance to the heat-transfer medium cannot be sufficiently synchronized with the fluctuations in the charge material according to the different needs to discharge and replace the catalytically active material, which may have become unusable, for example under the influence of halogen or sulfur compounds which have been introduced, as is in principle possible with the method described under [1].

The invention described here is based on the object of providing a simple method for generating a high-quality, undiluted product gas, with a high calorific value, from liquid to pasty charge materials with a low level of outlay on apparatus and operators, which on the one hand, as essential features, includes the generation of the process heat required by separate firing of a fuel, which in the absence of pyrolysis coke may be the product gas generated or also the pyrolysis gas formed as an intermediate stage, and the use of heat-transfer medium for well-defined heat transfer to the process media, and on the other hand avoids the use of fluidized beds or heat exchangers with a high temperature on both sides, and allows the use of heat-transfer medium and material which has a catalytic effect on the process to be controlled independently of one another.

This object is achieved by the combination of features described in claim 1. Analogously with [4], the basic idea is to divide the method into three method steps which are simple to carry out: rapid pyrolysis, production of the product gas from the pyrolysis gases after process steam has been admixed in homogeneous gas phase reactions with heat being supplied, and generation of the heat required for the pyrolysis and the gas phase reactions by combustion of a fuel outside the pyrolysis and the subsequent homogeneous gas phase reaction. Analogously to [4], the pyrolysis and the homogeneous gas phase reactions are carried out or kept going with the aid of heat-transfer medium. However, the idea of splitting the second reaction zone into a zone in which, as in [4], the pyrolysis gas and the reagent are heated by the heat-transfer medium and a further zone—referred to below as the third reaction zone—in which the mixture which has been heated to the desired reaction temperature and is already reacting comes into contact with the catalytically active solid(s) and reacts fully in this zone, as described in [1, 2], to form a product gas predominantly comprising hydrogen represents a significant extension to this concept. Since the reaction conditions in the third reaction zone do not differ from those used in the method presented in [1, 2], if calcium oxide is used as catalytically active material, the temperatures in this zone can be limited to 800° C. The second and third reaction zones are referred to below as the “reforming”. During the reforming, the usual reactions occur, which can be summarized, by way of example, as follows:

CₙHₘ+nH₂O→nCO+(m/2+n)H₂

In this method, the catalytically active solid is heated independently of the heat-transfer medium, is passed through the third reaction zone without contact with the heat-transfer medium and is finally extracted via a cooling zone, in which it is brought into contact with air, during which process any carbon formed at the particles can burn off. The air which is preheated in the process can be used to generate the process heat.

A development which is useful with a view to improving the product gas quality is provided by the possibility of connecting a further zone, which is separate in apparatus terms and in which initial heating of the catalytically active solid is effected not by flue gas from the firing required to obtain the process heat but rather by direct transfer of the sensible heat contained in the product gas, upstream of the heating reactor for the catalytically active solid. This is because, if, by way of example, granules of calcium oxide or calcium hydroxide are used as the catalytically active solid, at the temperatures in the range from 400-800° C. which are established here, it can be used to deacidify the product gas, i.e. to remove carbon dioxide and other acidic species, such as for example hydrogen halides or hydrogen sulfides, with the result that the usability of the product gas as synthesis gas, reducing agent, etc. can be significantly improved. This zone is referred to below as the “deacidification”.

All the abovementioned reaction zones, pyrolysis, second and third reaction zones, heating of heat-transfer medium and catalytically active substance, deacidification and cooling zone, can be implemented as shaft reactors, i.e. as vessels without any internal fittings. It is necessary for a free-flowing bulk material in the form of coarse grains to fine lumps to be used as catalytically active substance. A fundamental exception is the firing, as will be explained below. It may also be recommended for the pyrolysis apparatus to deviate from this condition, as will likewise be explained below. An advantageous configuration of the reforming with the second and third reaction zones consists in it being carried out in a twin-flue reactor in which the third reaction zone lies in the center, surrounded by the second reaction zone. In this way, the third reaction zone is kept warm by the heat-transfer medium in the second reaction zone.

Overall, the method is distinguished by the fact that caking resulting from possible soot formation or other cracking processes can be tolerated, since the circulation of the heat-transfer medium means that the heat-transfer surfaces are constantly regenerated, and since the substance which has a catalytic action in the third reaction zone is guided through the process in a single pass. Of course, it is also possible to recycle this substance after suitable regeneration, provided that such regeneration is possible with an acceptable level of outlay or if the costs of this substance require it to be recycled.

According to the invention, the pyrolysis of the liquid to pasty organic substance is carried out in a reactor which, with the maximum possible apparatus simplicity and robust operation, allows the heat required for the heating, drying and pyrolysis to be transferred as effectively as possible. Since the charge substance, on account of its consistency, immediately penetrates into the bulk bed formed by the incoming heat-transfer medium, with the result that the abovementioned operations can take place very quickly, unlike in [4], the pyrolysis reactor in which the at least partial evaporation also takes place can be of simple design and can be optimized to the discharge of the heat-transfer medium. By way of example, an open worm trough is suitable for this purpose. The pyrolysis temperature is preferably in a range between 500 and 650° C.

It is not necessary to separate pyrolysis coke out of the heat-transfer medium, but any ash-containing constituents should be discharged at this point. Coarse-grained heat-transfer medium can be separated, for example, mechanically by means of a simple screening arrangement. In this case, it is assumed that the introduction of solids of the size of the heat-transfer particles via the charge material can be completely avoided. In this context, it is expedient for the temperature of the media which are to be separated to be only approx. 500-600° C., so that it is possible to have recourse to commercially available materials. A further suitable option is gas classification if the heat-transfer medium has a sufficient density. In this case, a suitable classification fluid is the combustion air for the generation of process heat, or preferably, for safety reasons, a partial stream of recycled flue gas.

The firing comprises a combustion chamber with an end-side burner which can be arranged in any desired position. This can be operated with the following fuels: product gas, externally supplied fuel gas, e.g. natural gas, top gas, coke-oven gas, liquefied gas, or a liquid fuel, e.g. fuel oil, heavy oil, and, if suitable, also the liquid, organic charge substance which is to be gasified. If the air which has been heated in the cooling zone or the classification medium is used to separate out ash—be it air or recycled flue gas—the firing is to be configured in such a way that dust does not lead to operating problems or the air is to be prefiltered.

One further boundary condition applies to the firing: at a given reforming temperature, the flue gas is to be discharged at the end of the firing at a temperature which takes account of the heat losses on the way to the heating zone, the concentration of heat transfer to the heat-transfer medium within the heating zone and the concentration of the heat-transfer medium during the heat transfer in the second reaction zone during the reforming. For example, if the temperature of the reforming is 1000° C., the heat-transfer medium should be at a temperature of approximately 1050° C. when it enters this zone. If the heating zone is designed accordingly, this can be achieved with flue gas at a temperature of 1075° C. To cover the losses on the way from the firing to this heating zone, the off-gas must be slightly hotter when it leaves the firing, i.e. for example at a temperature of 1100° C.

Finally, the admixing of process steam to the pyrolysis gases before the reforming should also be dealt with: this is imperative if the liquid to pasty organic charge substances contain little or no water. The admixing must be in excess with respect to the expected homogeneous gas phase reactions with steam, since only in this way can the possible formation of soot be reliably prevented. A starting point in this respect is to maintain a certain steam concentration in the fresh product gas, specifically, for example, 25% by volume or more. On the other hand, it is likely that quantitative control of the addition of process steam with a steam concentration as the measurement variable could be highly complex and expensive. It ought to be better to set a fixed value which is implemented as a function of capacity by means of a quantitative measurement which is always possible. One possible configuration of the method according to the invention which should at least be mentioned at this point consists in selecting the location at which the process steam is mixed with the pyrolysis gas. Although this must take place at the latest before the second reaction zone, the reformer, is entered, it can nevertheless be shifted upstream into the pyrolysis reactor, where it can take place anywhere inside the pyrolysis reactor, all the way down to its bottom end. In this context, the bottom end of the pyrolysis reactor is understood to mean the outlet for the mixture of heat-transfer medium and the solid, carbonaceous residue. Although this causes the distribution of heat between pyrolysis and reforming to be altered, ultimately the flushing of the pyrolysis with steam when steam is added in the vicinity of the solid-side outlet from the pyrolysis reactor is advantageous in a number of respects: for example, the temperature of the pyrolysis gas on the way to the second reaction zone is not reduced anywhere, and consequently there is no likelihood of condensation. Moreover, possible leakage of pyrolysis gas in the direction of the discharge of heat-transfer medium from the pyrolysis reactor is thereby prevented. The alternative to adding steam is to admix water to the charge substance, if the latter does not itself contain sufficient water. The advantage of this is the simplicity in terms of apparatus, in particular if the admixing takes place immediately before use and there are therefore no demands to be imposed in terms of the stability of any emulsion which may be formed. The drawback is that the enthalpy of vaporization for this added water is produced by the exergetically high-quality heat in the pyrolysis. Expectations are that a solution in which an emulsion with a low water content is provided and the remaining water is supplied as steam will be optimum, since in this way some water is immediately available to prevent the formation of soot even before steam can be admixed. By admixing anhydrous or low-water charge substances, charge substances with a high water content can be adjusted in such a way that a water content which is favorable for practical implementation results.

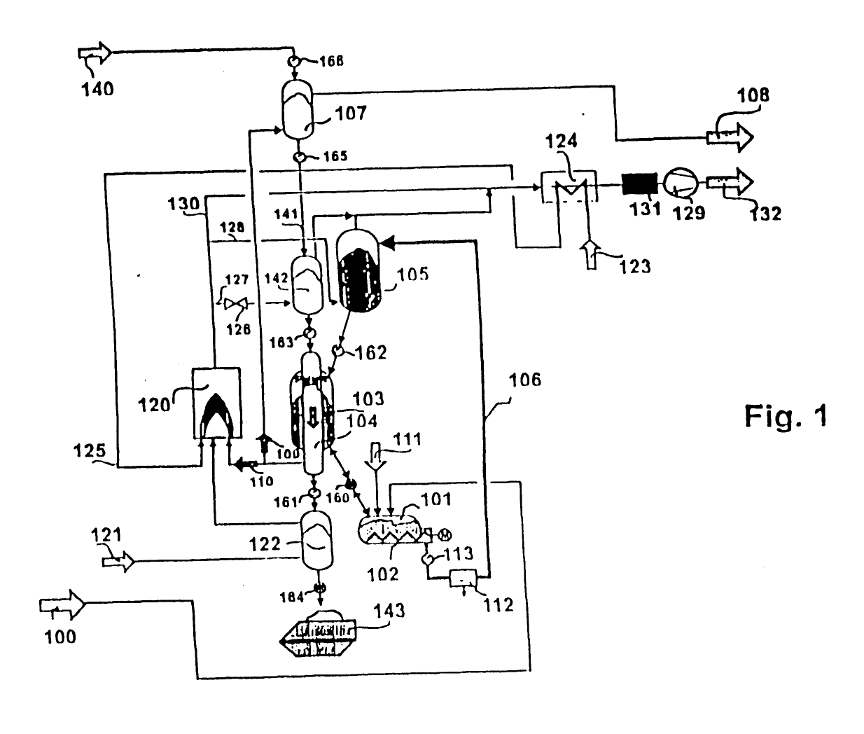

FIG. 1 shows a possible configuration of the subject matter of the invention. The liquid to pasty, organic charge substance 100 is under a sufficient delivery pressure, which may be generated, for example, by means of a delivery pump, and is fed directly into the pyrolysis reactor 101. The pyrolysis reactor 101 is preferably designed as a cylindrical shaft or a horizontal cylinder and has a base with the discharge device 102, which is illustrated here in the form of a worm. In addition to the charge substance, the heat-transfer medium, which comes from the second reaction zone 103 of the reformer, via the lock 160, also enters the pyrolysis reactor 101. The lock 160 can be of any desired form, but is preferably in the form of a rotary valve, a discharge roller (for example of the Ruskamp/Lufttechnik Bayreuth design) or a positional rotary slide, and should not be gastight. Moreover, the process steam stream 111 also enters; this stream is not specified in any particular way and may, for example, be low-temperature saturated steam.

First of all, the further path of the discharged volatile constituents will be described. These leave the pyrolysis reactor 101 in a mixture with the supplied process steam 111 via a separate line or preferably via the lock 160, in countercurrent with respect to the heat-transfer medium, toward the reformer with the second reaction zone 103. The path via the lock 160 and therefore the elimination of the separate line is possible if the lock 160 can be designed to be permeable, in such a manner that gas can pass through it without restriction at any time while the heat-transfer medium can only pass through in metered form or cyclically as part of the rotary lock operation. This is because while the heat-transfer medium must only enter the pyrolysis reactor 101 in metered form, with the possibility of interrupting the incoming flow altogether, it must always be possible for the entire quantity of pyrolysis gas as well as the admixed process steam 111 to escape from the pyrolysis apparatus without being impeded. By suitably designing the base of the second reaction zone 103 of the reformer, the stream of volatile constituents out of the pyrolysis is passed through the bed of heat-transfer medium located in the reformer over a path which is as long as possible. This bed of heat-transfer medium moves from the top downward, in countercurrent with respect to the gas mixture which reacts to form product gas when it is heated, and in the process is cooled. In the upper part of the reformer, the reacting gas mixture is diverted into the third reaction zone 104 of the reformer. The third reaction zone 104 lies concentrically inside the second reaction zone 103 and is separated from the latter by a wall which is impermeable to matter. In the example, within the third reaction zone lime (CaO), as catalytically active substance, flows downward in cocurrent with the reacting gas mixture. In the third reaction zone 104, the latter is converted to the product gas by the action of the lime, i.e. residual hydrocarbons are broken down and are partially oxidized further to form the main constituents of the product gas, hydrogen H₂ and carbon monoxide CO. This leaves the reformer at the bottom and is divided into the product-gas stream 109, which leaves the installation as cooled product-gas stream 108 via the decalcinator (deacidification reactor) 107, in order to be purified and conditioned for the consumer, and the product-gas partial stream 110, which is burnt in the combustion chamber 120 in order to generate process heat. In addition to the decalcinator 107, it is also possible to provide a waste-heat system, for example for generating the steam stream 111, but this is not shown here. The function of the decalcinator is explained below.

In the example illustrated, calcium oxide (CaO) is supplied (140) as catalytically active substance, entering the decalcinator 107 via the lock 166. This has two effects: in addition to the cooling of the product gas, during which the calcium oxide takes up heat, it withdraws some of the carbon dioxide (CO₂) content from the product gas 109 flowing in at temperatures of from 400 to 800° C. and, by means of this deacidification process, improves the quality of the product gas. Then, the lime, which has been partly converted into calcium carbonate (CaCO₃), enters the lime preheater 142, via the lock 165, where it is heated further to up to 1050° C. by the incoming hot-gas stream 127 and is partially calcined again, expelling CO₂. It then enters the third reaction zone via the lock 163, as described above. Depending on demand, it is extracted from this third reaction zone via the lock 161 into the cooling zone 122, which is designed as a shaft reactor, where it is combined with the part stream 121 of the combustion air required in the firing 120. As a result, the lime is cooled, and moreover any adhering carbon can burn off. The cooled, used lime is then extracted into the residue container 143 via the lock 164 and is at least not directly reused in the method. The consumption of lime depends, inter alia, on the level of pollutants, such as sulfur and halogens, in the incoming stream 100 and also on the desired degree of deacidification and cooling of the product gas in the decalcinator 107. In the present example, the lime is passed through the process in a straight line from the top downward, since it is likely that the lime particles will have poor flow properties. The flow properties are in this case substantially dependent on the geometry and the mean grain size.

The following text is intended to follow the path of the heat-transfer medium further. It enters the separation stage 112 through the discharge device 102 and the lock 113. The action of this separation stage 112—mechanical by screening or classification—has already been described above. The ash which is separated off, if present, is discharged in the conventional way. Then, the heat-transfer material is conveyed into the heat-transfer medium preheater 105 with the aid of the conveyor member 106. The preheater 105 as a heating zone for the heat-transfer medium is a container which does not contain any internal fittings and the inflow side of which for the heat-transfer medium is matched to the nature of the conveyor member 106. The latter is to be optimized according to the particular objective of conveying the selected heat-transfer medium upward while minimizing heat losses, mechanical abrasion of the heat-transfer medium particles and the force required. Accordingly, the conveyor member may be a bucket conveyor, a tubular chain conveyor, a pneumatic conveyor, a scoop elevator or the like. Hot flue gas (128) flows through the preheater 105 from the bottom upward, heating the heat-transfer medium from a temperature which, on account of inevitable heat losses, is below the pyrolysis outlet temperature and is to be referred to as the “base temperature” to up to 1050° C. The heated heat-transfer medium is extracted at the underside of the preheater via the lock 162, which is as far as possible gastight, and metered into the second heating zone 103 of the reformer. In a similar manner to the path of the lime, the path of the heat-transfer medium passes through the preheater 105, the lock 162, the second heating zone 103, the lock apparatus 160 and the pyrolysis reactor 101 from the top downward without any significant horizontal components, with the result that here the conveying can be effected by means of the force of gravity.

Last of all, the generation of process heat together with the associated off-gas path will be described: the upright combustion chamber 120 fired from below, which in this case is selected to be cylindrical, is in the example selected fed by the product-gas partial stream 110, the abovementioned air stream 121 and the supplementary air stream 125. The latter is generated from the fresh-air stream 123 by heating in the air preheater 124. The excess of air of the combustion is set in such a way that the off-gas streams 127 and 128 are at a temperature which on the one hand is suitable for heating lime and heat-transfer medium to up to 1050° C., but on the other hand does not yet cause any materials problems. The off-gas stream 127 required to heat the lime can be set according to demand with the aid of the throttle member 126. The off-gas stream 128 is used to heat the heat-transfer medium and cannot be throttled. The off-gas is delivered by means of the extractor fan 129. The bypass 130 of the two preheaters enables the combustion chamber 120 to be used as a safety feature but is of no importance for normal operation.

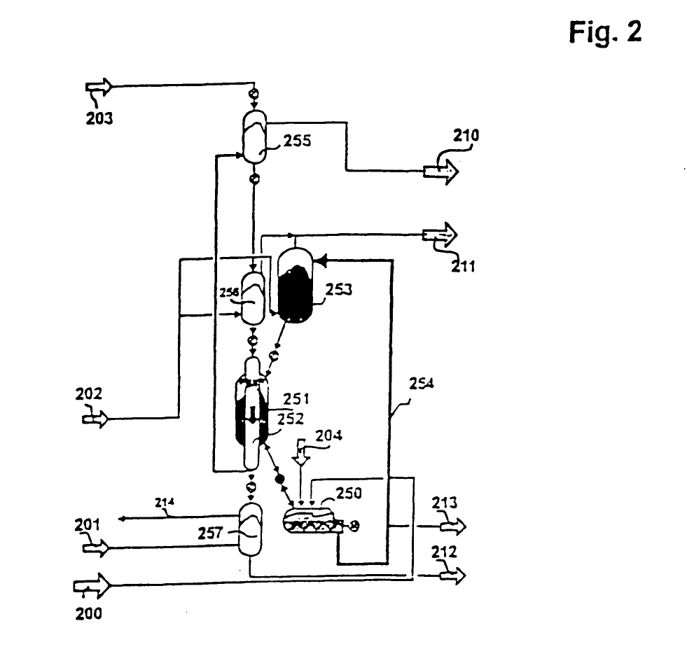

The off-gas leaves the preheaters 105 and 142 at a temperature which is slightly above the base temperature. The quantity of off-gas is generally considerably greater than the quantity of product gas. Consequently, it is highly recommended to utilize the waste heat of the off-gas after it leaves the preheater. This is preferably effected by preheating the combustion air in the air preheater 124, since in this way the heat recovered after the combustion is again available for exergetic utilization at above the base temperature of approx. 500° C. This type of heat shift cannot be produced, or can only be produced with a disproportionately high level of outlay, for steam generation. After the air preheater 124, the entire flue-gas stream leaves the installation via the extractor fan 129 and the purification stage 131, which is to be configured as a function of the charge substance and the current statutory emission limits and the action of which is known per se. The purified off-gas 132 is generally discharged to atmosphere; a part stream—not shown here—can be returned to the firing 120 in order to improve temperature management. While FIG. 1 diagrammatically depicts, by way of example, an arrangement of an autarkic installation, FIG. 2 aims to show how the minimum configuration of an installation according to the invention can be incorporated in a higher-level overall process, i.e. what are the minimum incoming and outgoing streams required for an installation of this type.

FIG. 2 shows the process engineering core of the installation in simplified form, having the components which have already been extensively described in connection with FIG. 1, in this case, in the illustration, the following: pyrolysis apparatus 250, reformer having the second heating zone 251 and the third heating zone 252, in which reacting gas mixture and catalytically active material (for example lime) are brought into contact, heating zone for the heat-transfer medium 253, heat-transfer medium circuit 254, decalcinator 255, preheater 256 and cooling zone 257 for the catalytically active medium. These are the essential components for the method according to the invention having the features of main claim 1, with regard to the cooling zone 257, of claim 2, with regard to the decalcinator 255, of claim 3. The abovementioned criterion applies to the charge substance 200, namely that it must be available under a sufficient admission pressure. This means that it can be supplied from a plant mains but also from a suitable supply station, but this is of no importance to the method. The same is true of the cooling air 201. The heated, outgoing air 214 can be reused as desired. Its use in the firing to generate process heat as described in FIG. 1 serves merely to optimize the energy of the overall process but is by no means imperative. It is equally by no means imperative for the hot gas 202 to be generated from a part stream of product gas. If the installation using the method according to the invention forms part of a steelworks, the hot gas 202 may be hot-blast air. It is equally conceivable to use a part stream of a flue gas which is present at a suitable temperature or to generate the hot gas from a fuel which does not correspond to either the charge substance 200 or the product gas or an intermediate state between pyrolysis gas and product gas. The only additional demand to be imposed on the catalytically active material 203 which is to be supplied is that it be in the form of fine lumps of a size which is as uniform as possible, so that the pressure loss in the apparatus 252, 256 and 257 is kept as low as possible.

In any event, the product gas 210 does not have to be purified and cooled, and even the deacidification in the decalcinator 255 is not obligatory, specifically if, for example, the CO₂ content of the product gas 210 does not cause problems, as for example during combustion in a gas turbine. The off-gas 211 from the hot gas 202 can be treated in a purification stage dedicated to the plant, can be added to a higher-level flue-gas treatment system or, if 202 is hot-blast air, can be added to another process, for example as preheated combustion air. The air preheater shown in FIG. 1 is used merely to optimize the energy in a stand-alone plant.

Finally, the use of the consumed, catalytically active material 212 and of the ash 213 depends on the quality of the charge substance 200 and the embedding of the plant in existing infrastructure.

Exemplary Embodiment

In the device shown in FIG. 1, 286 kg/h of an emulsion with a water content of 30%, i.e. 200 kg/h of organic phase, are gasified. The organic phase substantially comprises 84.5% of carbon, 15% of hydrogen, 0.3% of nitrogen and small quantities of chlorine and sulfur. The lower calorific value is 40.0 MJ/kg in the anhydrous state. The thermal gasifier power is consequently 2224 kW. The pyrolysis is carried out at 550° C. and the reforming is carried out using steam at 950° C. The working pressure is atmospheric pressure.

The heat-transfer medium used is steel balls with a size of approximately 10 mm. The heat-transfer medium is firstly heated from 500 to 950° C. On account of the required heat power of 632 kW for the pyrolysis and the reforming and to cover heat losses, the circulated quantity of heat-transfer medium is 12 600 kg/h, i.e. 44 times the quantity of emulsion. In addition, lime is used in a quantity which theoretically allows the product gas to be completely deacidified, i.e. allows all the CO₂ formed as well as all the sulfur- and chlorine-containing species to be bonded to the lime. The inventive use of the lime in the third reaction zone, i.e. in the reformer, as catalytically active material is not, however, accompanied by a quantifiable consumption. In the example described, in theory 7.42 kmol/h of CaO, i.e. 416 kg/h, are required, essentially forming 741 kg/h of CaCO₃. The sensible heat of this residual material remains almost completely in the process.

The pyrolysis reactor is a trough which is closed at the top and has a volume of approx. 0.25 m³, with the result that a residence time of 10 minutes is reliably available to the pyrolizing migrating bed. In the pyrolysis, the emulsion is completely converted into the gas phase and discharged to the reformer. The reforming takes place at 950° C. in a bulk bed of heat-transfer medium and a bulk bed of lime in each case with an overall cylindrical height of 0.9 m, the bulk bed of lime having an overall diameter of approximately 1.1 m and the bulk bed of heat-transfer medium having an overall external diameter of approximately 1.6 m and an overall internal diameter of 1.1 m, so that a gas residence time of 0.5 sec per reaction zone can be reliably maintained. In this way, the following product gas is obtained:

| | |
|---|---|
| Calorific value: | 10.99 MJ/kg, dry |
| Hydrogen: | 72.2% by volume dry |
| Carbon monoxide: | 23.7% by volume dry |
| Methane: | 2.4% by volume dry |
| Carbon dioxide: | 1.4% by volume dry |
| Steam: | 28.0% by volume |
| Quantity: | 848 m³/h (s.t.p.) |
| Chemical enthalpy flow: | 1908 kW |

This quantity already takes account of the fact that a quantity of product gas of the same composition corresponding to the enthalpy flow of 849 kW has already been extracted into the firing. This is used to generate the heat for the reforming, pyrolysis, waste water evaporation from the product-gas cooling and to cover the heat losses and to heat the combustion air required in the firing to 350° C. The firing efficiency is 80%, and consequently the off-gas loss is 170 kW. The sensible heat of the product gas is 338 kW, with which it is possible to generate approximately 292 kg/h of a saturated steam at low pressure, of which 280 kg/h are required as process steam in the reforming, while the remainder can be used in other ways.

[1] PCT document WO99/04861

[2] Th.-M. Sonntag, DGMK-Tagungsbericht [DGMK Conference Report] 2000-1

(ISBN 3-931850-65-X), 57-64

[3] DE-C 197 55693

[4] T. Dimova, C. Schmid, H.-J. Muhlen, DGMK-Tagungsbericht [DGMK Conference Report] 2000-1

(ISBN 3-931850-65-X), 39-46.

1. A method for the gasification of liquid to pasty organic substances and substance mixtures, in which the organic substances are substantially converted into a volatile phase in a pyrolysis reactor by contact with a hot heat-transfer medium, the volatile phase, possibly after a reagent, such as steam, has been mixed in, is reheated by heat exchange in a second reaction zone in such a manner that a product gas with a high calorific value is obtained, and a flow of a hot gas, as it cools, is used to heat the heat-transfer medium, characterized in that
a) the heat-transfer medium, after it has left the pyrolysis reactor, is separated from a solid, carbonaceous pyrolysis residue in a separation stage and is conveyed into a heating zone,
b) the hot off-gases from the firing, in the heating zone, are passed through a bed of the heat-transfer medium, releasing a large proportion of their sensible heat to the heat-transfer medium,
c) the heated heat-transfer medium is extracted from the heating zone into the second reaction zone, which is designed as a migrating bed reactor, where it heats the mixture of pyrolysis gases and reagent and at least partially converts it into the product gas,
d) the heat-transfer medium, after it has passed through the second reaction zone, is fed back to the pyrolysis reactor,
e) the heated and partially reacted gas mixture, following the second reaction zone, is passed into a third reaction zone, in which it reacts fully with a catalytically active material, which has been heated to reaction temperature and is different than the heat-transfer medium, to form the product gas.

2. The method as claimed in claim 1, characterized in that the catalytically active material is cooled by heating combustion air and is then discharged and either discarded or reused after regeneration.

3. The method as claimed in either of claims 1 and 2, characterized in that the catalytically active material is heated by the sensible heat of the product gas and in the process reacts chemically with at least one species of the product gas.

4. The method as claimed in one of claims 1 to 3, characterized in that the heat-transfer medium and the catalytically active material are heated and passed through the process separately from one another.

5. The method as claimed in one of claims 1 to 4, characterized in that the catalytically active material is heated by a hot gas stream, in particular off-gas.

6. The method as claimed in one of claims 1 to 5, characterized in that at least one of the two streams comprising heat-transfer medium and catalytically active material is heated in two separate process stages, arranged in series or in parallel, by product gas and by a hot gas stream, in particular off-gas.

7. The method as claimed in one of claims 1 to 6, characterized in that the separation of the heat-transfer medium from solid residue which is present takes place after leaving the pyrolysis reactor by mechanical means using a single-stage or multistage screening arrangement.

8. The method as claimed in one of claims 1 to 7, characterized in that the separation of the heat-transfer medium from the solid, carbonaceous residue after leaving the pyrolysis reactor is carried out pneumatically with the aid of gas classification.

9. The method as claimed in one of claims 1 to 8, characterized in that at least one of the following media is conveyed discontinuously or in batches: organic substance, heat-transfer medium, mixture of heat-transfer medium and solid pyrolysis residue on leaving the pyrolysis reactor, catalytically active material.

10. The method as claimed in one of claims 1 to 9, characterized in that the sensible heat of the product gas and of the off-gas from the firing is at least in part used to generate the steam as a reagent or to preheat the air for the firing.

11. The method as claimed in one of claims 1 to 10, characterized in that the sensible heat of the product gas and of the off-gas from the firing is at least in part utilized directly or indirectly to heat the organic liquid to pasty substance.

12. The method as claimed in one of claims 1 to 11, characterized in that the heat-transfer medium selected is a solid material which is in the form of fine lumps or granules and substantially retains its properties under the reaction conditions which it alternately passes through.

13. The method as claimed in one of claims 1 to 12, characterized in that the catalytically active material selected is a metal oxide, in particular calcium oxide.

14. The method as claimed in one of claims 1 to 13, characterized in that the reagent which is to be admixed upstream of the second reaction zone is added to the pyrolysis reactor at any desired location.

15. The method as claimed in one of claims 1 to 14, characterized in that the heat which is to be fed to the heat-transfer medium originates from a firing stage and is fed to the heating zone in the form of hot off-gas.

16. The method as claimed in one of claims 1 to 15, characterized in that a fuel or a fuel mixture which is formed at least in part from organic liquid to pasty charge substance or a substance generated therefrom at any location within the method sequence or one of the products which it subsequently forms is used to heat the heat-transfer medium.

17. The method as claimed in one of claims 1 to 16, characterized in that the product gas is cooled, the condensate formed is purified if necessary and is reused to generate the process steam or is added to the firing stage or the heat-transfer medium for the purpose of evaporation and combustion of the combustible fractions contained therein.
